(19) United States
(12) Patent Application Publication
(10) Pub. No.: US 2023/0069206 A1
(43) Pub. Date: Mar. 2, 2023

(54) RECOVERY JUDGMENT APPARATUS, RECOVERY JUDGMENT METHOD AND PROGRAM

(71) Applicant: Nippon Telegraph and Telephone Corporation, Tokyo (JP)

(72) Inventors: Kei TAKESHITA, Musashino-shi, Tokyo (JP); Yuji SOEJIMA, Musashino-shi, Tokyo (JP)

(21) Appl. No.: 17/799,341

(22) PCT Filed: Feb. 12, 2020
(86) PCT No.: PCT/JP2020/005337

§ 371 Date: Aug. 12, 2022

(51) Int. Cl. H04L 41/0654; H04L 47/127

(52) U.S. Cl. CPC H04L 41/0654; H04L 47/127

(57) ABSTRACT

A restoration determination device 1 calculates, based on past traffic data of each user in a first NW device, a current estimated traffic amount of the user, compares the calculated current estimated traffic amount of the user with a current traffic amount of the user in a second NW device to which the first NW device is switched, and determines restoration by switching to the second NW device to be abnormal when the number of users for which the current estimated traffic amount is larger than zero but the current traffic amount is zero exceeds a threshold value.

### TECHNICAL FIELD

The present invention relates to a restoration determination device, a restoration determination method, and a restoration determination program.

### BACKGROUND ART

When a NW (network) device of a large-scale network has failed and is switched to a NW device in a redundant system, it is necessary to check the normality (communication recovery or communication restoration) of the service status of the entire user. Hitherto, the normality has been determined based on the flow rate of traffic flowing through the IF of the NW device. Furthermore, the telemetry of NPL 1 can be used to acquire the flow rate of traffic of a user or a VLAN (Virtual Local Area Network) serving as a service unit (NPL 1).

### CITATION LIST

### Non Patent Literature

[NPL 1] “Issues of SNMP and background of emergence of Telemetry”, thorough explanation of “Telemetry” for next-generation network monitoring (part 1), businessnetwork.jp, [retrieved on Jan. 31, 2020], the Internet <URL:https://businessnetwork.jp/Detail/tabid/65/art id/6167/Default.aspx>

### SUMMARY OF THE INVENTION

### Technical Problem

Conventionally, the technique of determining the normality of the service status of a user is mainly a technique of monitoring the traffic flow rate in units of NW device or IF. However, the traffic flow rate is different for each user, and thus the communication recovery status of an individual user terminal cannot be checked with the total traffic amount of all the user terminals accommodated in the VLAN. In recent years, the traffic flow rate of the VLAN, which often corresponds to usage by a user, has been successfully acquired by using telemetry. However, the traffic flow rate changes when the user uses a network service. Thus, it is not possible to distinguish between a user who does not use a network service and a user who cannot use a network service, and the communication recovery status of an individual user cannot be grasped accurately. Therefore, there is a problem in that the normality of the service status of the entire user cannot be checked immediately after switching to the redundant system.

The present invention has been made in view of the above-mentioned circumstances, and an object of the present invention is to provide a technology capable of checking the normality of the service status of the entire user.

### Means for Solving the Problem

A restoration determination device according to one aspect of the present invention calculates, based on past traffic data of each user in a first NW device, a current estimated traffic amount of the user, compares the calculated current estimated traffic amount of the user with a current traffic amount of the user in a second NW device to which the first NW device is switched, and determines restoration by switching to the second NW device to be abnormal when the number of users for which the current estimated traffic amount is larger than zero but the current traffic amount is zero exceeds a threshold value.

A restoration determination method according to one aspect of the present invention is a restoration determination method to be executed by a restoration determination device, the restoration determination method including: calculating, based on past traffic data of each user in a first NW device, a current estimated traffic amount of the user; comparing the calculated current estimated traffic amount of the user with a current traffic amount of the user in a second NW device to which the first NW device is switched; and determining restoration by switching to the second NW device to be abnormal when the number of users for which the current estimated traffic amount is larger than zero but the current traffic amount is zero exceeds a threshold value.

One aspect of the present invention is a restoration determination program for causing a computer to function as the above-mentioned restoration determination device.

### Effects of the Invention

According to the present invention, it is possible to provide the technology capable of checking the normality of the service status of the entire user.

### BRIEF DESCRIPTION OF DRAWINGS

FIG. 1 is a reference diagram for describing an outline of the invention.

FIG. 2 is a reference diagram for describing an outline of the invention.

FIG. 3 is a reference diagram for describing an outline of the invention.

FIG. 4 is a diagram illustrating a functional block configuration of a restoration determination device.

FIG. 5 is a diagram illustrating a processing flow of an operation of collecting traffic data.

FIG. 6 is a diagram illustrating a processing flow of an operation of learning the traffic data.

FIG. 7 is a diagram illustrating a processing flow of an operation of estimating a communication restoration period of each user.

FIG. 8 is a diagram illustrating a processing flow of an operation of determining communication restoration of a user.

FIG. 9 is a diagram illustrating an example of determining communication restoration.

FIG. 10 is a diagram illustrating a hardware configuration of the restoration determination device.

### DESCRIPTION OF EMBODIMENTS

Now, an embodiment of the present invention is described with reference to the drawings. In the description of the drawings, the same components are assigned with the same reference numerals, and description thereof is omitted here.

[1. Outline of Invention]

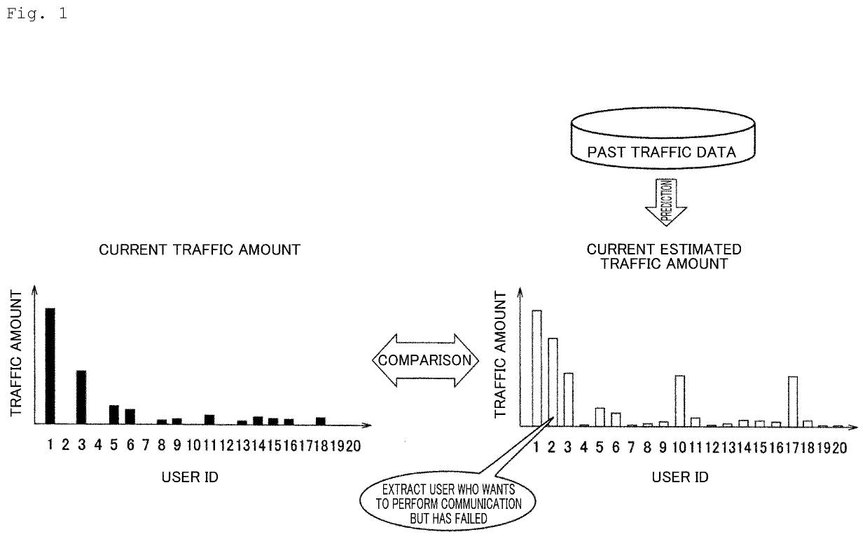

In order to solve the above-mentioned problem, the present invention first uses prediction data of a traffic amount. Specifically, as illustrated in FIG. 1, a current traffic demand of each user is predicted based on past traffic data, the predicted current traffic amount and a current traffic amount flowing after switching to a redundant system are compared with each other, and when the number of users (ID=2, 10, 17) for which the current traffic demand is not satisfied exceeds a threshold value, restoration by switching to the redundant system is determined to be abnormal. Prediction for an individual user may or may not be true, and thus the present invention integrates comparison results of a plurality of users and performs determination. In this manner, the present invention can provide the technology capable of checking the normality of the service status of the entire user.

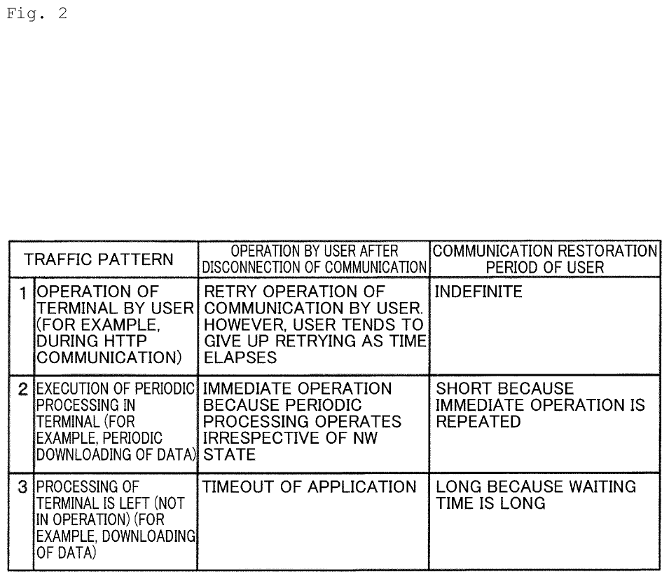

Furthermore, the present invention secondly determines the degree of smoothness of restoration after switching by using a statistical learning model based on the past restoration status of a user. In general, a communication restoration period (period between communication disconnection time and communication resumption time at which communication is started first after switching to redundant system) of a user since disconnection of communication until the user resumes communication differs depending on a traffic pattern immediately before disconnection of communication as illustrated in FIG. 2. For example, when a network service is used immediately before disconnection of communication, the communication restoration period of the user tends to be short. On the other hand, when a network service is not used immediately before disconnection of communication, the communication restoration period of the user tends to belong. Thus, the current estimated traffic amount to be used for determination may not be appropriate depending on the timing of the above-mentioned determination.

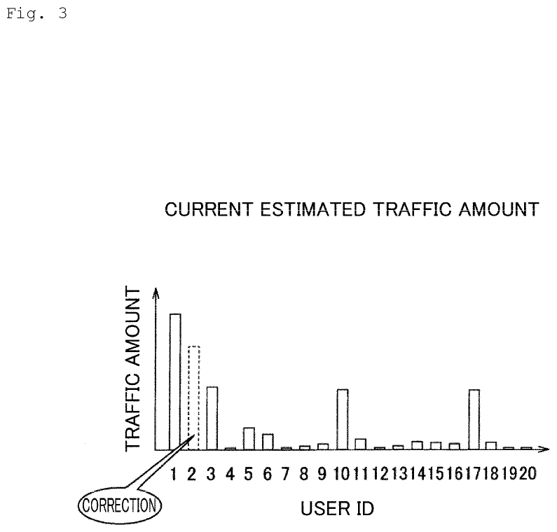

In view of this, the present invention has learned in advance the past communication restoration period of each user for each traffic pattern, and when the above-mentioned determination is performed, the present invention uses a current estimated traffic amount of each user, which considers the communication restoration period of each user that depends on the traffic pattern immediately before switching to the redundant system. Specifically, the present invention has generated in advance a communication restoration estimation model by collecting and learning a traffic pattern (clustering of time-series data), a communication disconnection time, and a communication resumption time at the time of failure, and after switching to the redundant system, uses the communication restoration estimation model to calculate a communication restoration period of a user that depends on the traffic pattern immediately before switching. Then, as illustrated in FIG. 3, the present invention considers, for a user for which the current estimated traffic amount is zero at the time of determination, that the current estimated traffic amount of the user (ID=2) is zero, and determines, except for the current estimated traffic amount of that user, whether or not there are a large number of users for which the above-mentioned current traffic demand is not satisfied. In this manner, the present invention improves the above-mentioned determination accuracy. As a result, the present invention can provide the technology capable of checking the normality of the service status of the entire user accurately and immediately.

[2. Configuration of Restoration Determination Device]

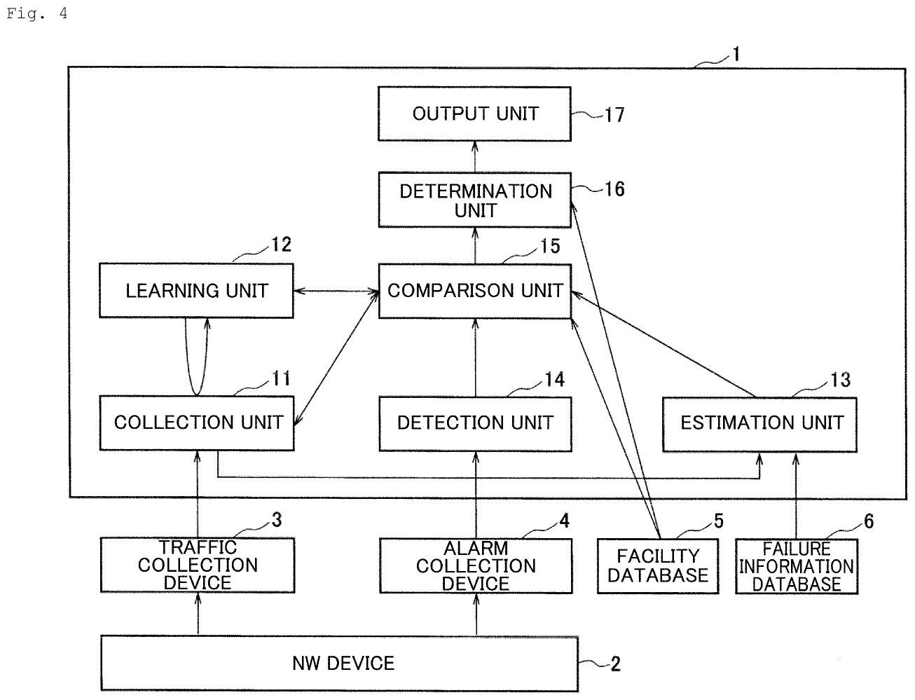

FIG. 4 is a diagram illustrating a functional block configuration of a restoration determination device 1 according to this embodiment. The restoration determination device 1 includes a collection unit 11, a learning unit 12, an estimation unit 13, a detection unit 14, a comparison unit 15, a determination unit 16, and an output unit 17. In FIG. 4, devices forming a large-scale network include a NW device 2, a traffic collection device 3, an alarm collection device 4, a facility database 5, and a failure information database 6. It is assumed that the NW device before switching is a NW device 2 (first NW device) and the NW device after switching is a NW device 2′ (second NW device). Now, the functions of the restoration determination device 1 are described.

The collection unit 11 has a function of collecting and storing traffic data of each user. For example, the collection unit 11 collects traffic data of each user from the traffic collection device 3 configured to collect traffic information on the NW devices 2 and 2′ and stores the traffic data.

The learning unit 12 has a function of acquiring traffic data of each user from the collection unit 11, and learning the acquired traffic data of each user to generate a traffic demand prediction model for calculating (predicting) the current estimated traffic amount of each user. A publicly known technique is used for the learning processing for generating the traffic demand prediction model.

The estimation unit 13 has a function of referring to past failure information stored in the failure information database 6, and learning, for each traffic pattern immediately before disconnection of communication, a communication restoration period of each user since disconnection of communication until the user resumes communication to generate a communication restoration estimation model for calculating (estimating) a communication restoration period of each user that depends on a predetermined traffic pattern. A publicly known technique is used for the learning processing for generating the communication restoration estimation model.

Furthermore, the estimation unit 13 has a function of acquiring traffic data of each user from the collection unit 11, and using the generated communication restoration estimation model to calculate a communication restoration period of each user that depends on the traffic pattern immediately before switching.

The detection unit 14 has a function of detecting an alarm (for example, a failure alarm, a switching alarm, or a restoration alarm) of the NW devices 2 and 2′ collected by the alarm collection device 4, and calling the comparison unit 15 when the detected alarm is a switching alarm of the NW device.

The comparison unit 15 has a function of extracting, after the NW device 2 is switched to the NW device 2′, a list of users accommodated in the NW device 2 from the facility database 5, and comparing the current estimated traffic amount of each user calculated by the learning unit 12 using the traffic demand prediction model with the current traffic amount of each user flowing through the NW device 2′ collected by the collection unit 11.

At this time, regarding the current estimated traffic amount of each user, when there is a user for which the current estimated traffic amount is zero at the time of determination of comparison based on the communication restoration period of each user calculated by the estimation unit 13, the comparison unit 15 excludes the current estimated traffic amount of that user.

The determination unit 16 has a function of determining, when the number of users for which the current estimated traffic amount is larger than zero but the current traffic amount is zero exceeds a threshold value as a result of comparison of traffic amounts by the comparison unit 15, restoration by switching to the NW device 2′ to be abnormal.

In particular, when there is a user for which the current estimated traffic amount is zero at the time of determination of comparison based on the communication restoration period of each user calculated by the estimation unit 13, the determination unit 16 performs the above-mentioned determination by using the current estimated traffic amount (traffic amount after the above-mentioned exclusion) of each user at the time of determination of comparison, which considers the communication restoration period of each user.

The output unit 17 has a function of outputting, to a GUI (Graphic User Interface), a normal status or an abnormal status of restoration, which is the result of determination by the determination unit 16, displaying the normal status or the abnormal status of restoration on a monitor screen, and outputting a warning sound or the like from a speaker.

[3. Operation of Restoration Determination Device]

[3.1. Collection of Traffic Data]

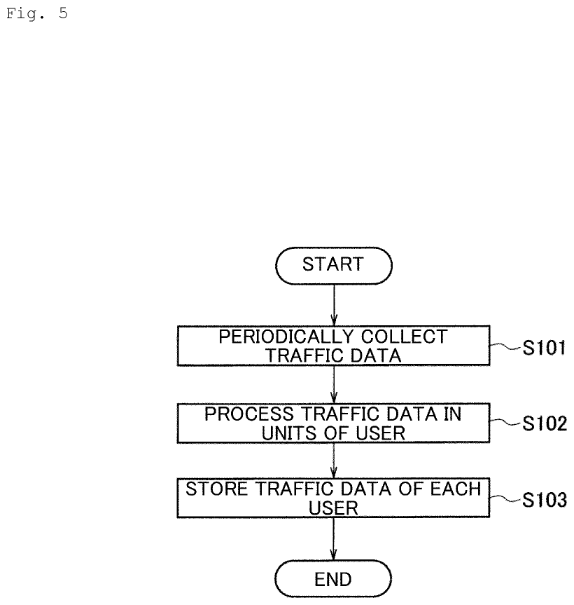

FIG. 5 is a diagram illustrating a processing flow of an operation of collecting traffic data.

Step S101

The collection unit 11 periodically collects traffic data flowing through the NW device 2 from the traffic collection device 3. For example, a telemetry collector is assumed as the traffic collection device 3, but the traffic collection device 3 is not limited to the telemetry collector. Furthermore, the traffic collection device 3 may be an information collection device capable of collecting various kinds of information including traffic data from the NW device 2.

Step S102

The collection unit 11 processes the collected traffic data in units of user or time to alleviate the processing load of the learning unit 12. The user is identified based on an identifier such as an IP address or a VLAN number, for example. Data in units of one minute is assumed as the time. When pieces of data (for example, data in units of second) have a granularity smaller than one minute, the representative value of those pieces of data is used. For example, a 90% value or the like is used. When there is only data having a granularity larger than one minute, data in units of one minute is interpolated and calculated by using interior division with a previous time interval, for example. The granularities of time are not limited to the above.

Step S103

The collection unit 11 stores the traffic data processed in units of user or time into a traffic database.

After that, the collection unit 11 returns necessary traffic data in response to requests from the learning unit 12, the comparison unit 15, and the estimation unit 13.

[3.2. Learning of Traffic Data]

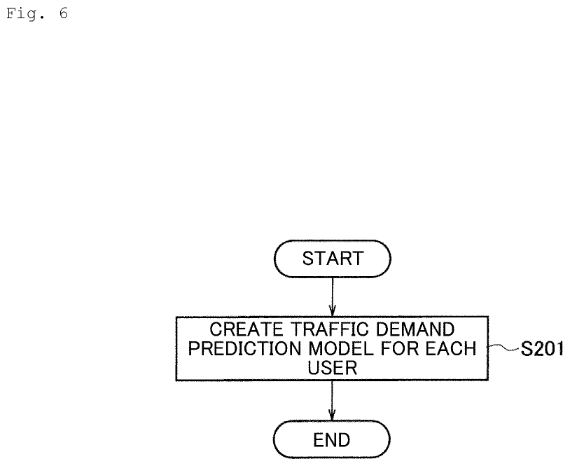

FIG. 6 is a diagram illustrating a processing flow of an operation of learning the traffic data.

Step S201

The learning unit 12 periodically reads traffic data from the traffic database, and predicts a traffic demand by using machine learning based on the read traffic data. For example, the learning unit 12 reads traffic data for about past one week for each user, and uses an algorithm capable of processing long-term time-series data such as an ARIMA model (autoregressive integrated moving average model), an LSTM (long short-term memory), or the like to create a traffic demand prediction model for each user, which is capable of predicting future time-series data. The prediction technique itself is a technique that utilizes temporal periodicity of traffic, and is used in various literatures such as Japanese Patent No. 6186303.

[3.3. Estimation of Communication Restoration Period of each User]

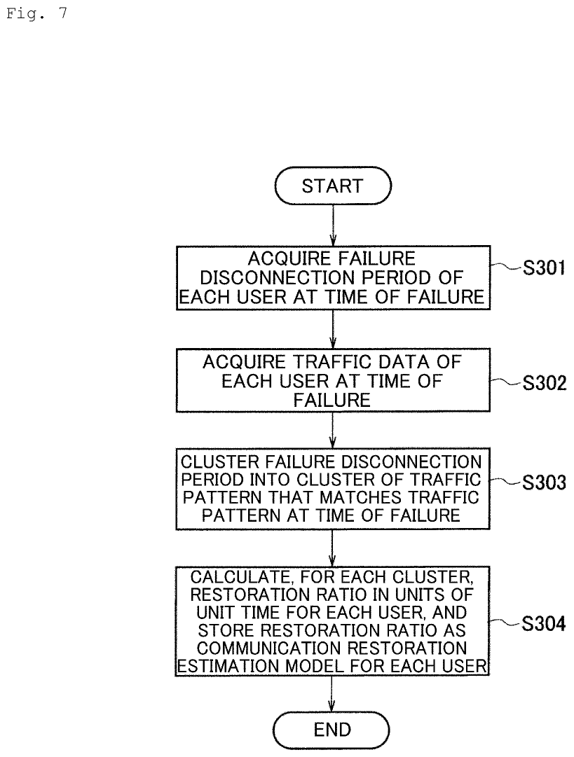

FIG. 7 is a diagram illustrating a processing flow of an operation of estimating a communication restoration period of each user. It is assumed that the estimation unit 13 operates every time the related NW device fails. The trigger for operation may be input by a maintenance person or periodic processing instead. The estimation unit 13 determines, for each traffic pattern, sensitivity (communication restoration period of each user) of restoration of a user for a failure disconnection period.

Step S301

The estimation unit 13 acquires, fora failure in a past certain period, from the failure information database 6, an ID of each user affected at the time of occurrence of the failure and the failure disconnection period of each user.

Step S302

The estimation unit 13 acquires, from the collection unit 11, traffic data of each user flowing at the time of occurrence of the above-mentioned failure.

Step S303

The estimation unit 13 grasps a traffic pattern at the time of occurrence of the failure based on the acquired traffic data, and clusters the acquired ID or failure disconnection period of each user into a cluster of a traffic pattern that matches the grasped traffic pattern at the time of occurrence of the failure. A publicly known technique is used for the clustering algorithm.

Step S304

The estimation unit 13 calculates, for users belonging to each cluster, a restoration ratio (=number obtained by dividing the number of restored users by the number of users in the cluster) of the users in units of one minute after recovery from the failure, and holds the restoration ratio as a communication restoration estimation model for the users.

After that, when the estimation unit 13 is called by the comparison unit 15, the estimation unit 13 determines, for each traffic pattern of a user, which cluster the user belongs to, and returns the restoration ratio of the user corresponding to the cluster that the user is determined to belong to.

[3.4. Determination of Communication Restoration of User]

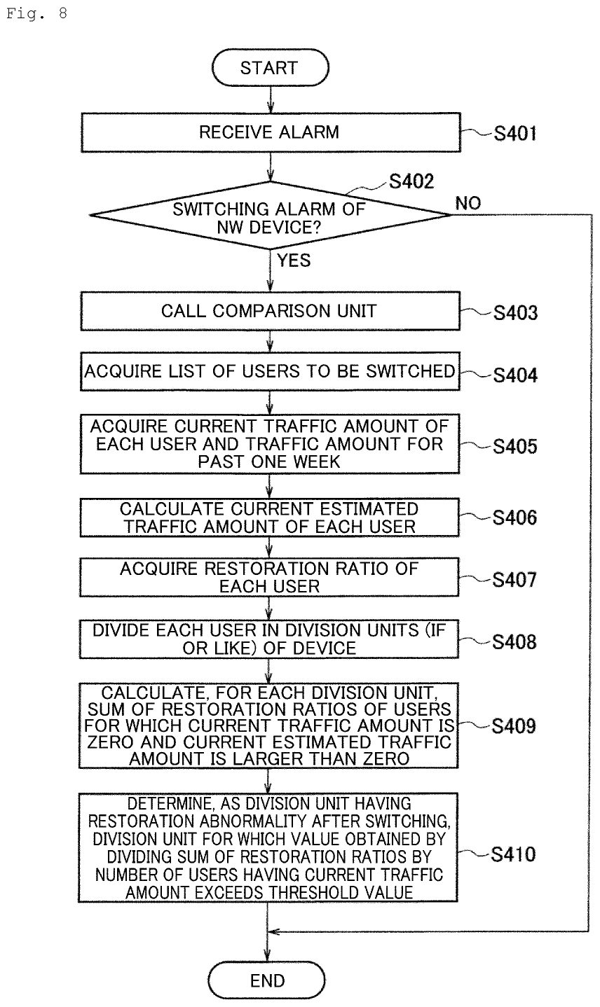

FIG. 8 is a diagram illustrating a processing flow of an operation of determining communication restoration of a user. At the time of occurrence of a failure of a NW device, an alarm is transmitted in a protocol such as an SNMP (Simple Network Management Protocol) from the NW device. The NM operator holds a system that aggregates and visualizes alarms of various kinds of devices, which is the alarm collection device 4 in this embodiment. When the NW devices 2 and 2′ serving as analysis subjects have transmitted alarms, the alarm collection device 4 transmits the alarms to the restoration determination device 1.

Step S401

The detection unit 14 receives the alarm of the NW device 2′ transmitted from the alarm collection device 4.

Step S402

The detection unit 14 determines whether the alarm received from the alarm collection device 4 is an alarm of a pattern that matches a switching alarm of an event in which the NW device is switched. When the pattern matches, the processing proceeds to Step S403. When the pattern does not match, the processing is finished.

Step S403

The detection unit 14 assigns information on a failure occurrence time and a failure occurrence device to the switching alarm received from the alarm collection device 4, and calls the comparison unit 15. The comparison unit 15 executes each processing of from the following Step S404 to Step S410 every minute until a restoration alarm is input in response to calling by the detection unit 14.

Step S404

The comparison unit 15 refers to the facility database 5 by using the affected NW device 2 as a key, and acquires a list of users to be switched.

Step S405

The comparison unit 15 acquires, for each user to be switched, from the collection unit 11, the current traffic amount flowing through the NW device 2′ and traffic data for past one week before the failure occurrence time.

Step S406

The comparison unit 15 inputs the acquired traffic data for past one week of each user to the learning unit 12 as input data, uses the traffic demand prediction model for each user to calculate the current estimated traffic amount after the failure occurrence time, and acquires the calculated current estimated traffic amount of each user.

Step S407

The comparison unit 15 causes the estimation unit 13 to calculate, based on traffic data for past one hour of each user, a restoration ratio (restoration ratio of user in units of one minute after recovery from failure) that depends on the traffic pattern of each user immediately before occurrence of the failure, and acquires the calculated restoration ratio of each user. After that, the comparison unit 15 transmits the current traffic amount, the estimated traffic amount, and the restoration ratio for all the users to the determination unit.

Step S408

The determination unit 16 refers to the facility information of the facility database 5 based on input data received from the comparison unit 15, and divides a group of users affected by the failure in division units (for example, region of counter-device, IF, sub-module, or the like) of NW devices.

Step S409

The determination unit 16 calculates, for each division unit, a sum of restoration ratios at the current time point after recovery from the failure for each user for which there is no current traffic (current traffic amount is zero) transmitted but the current estimated traffic amount is larger than zero. The value of the sum of restoration ratios is an estimation value of the number of users for which there is a communication demand but communication is disabled in the division unit.

Step S410

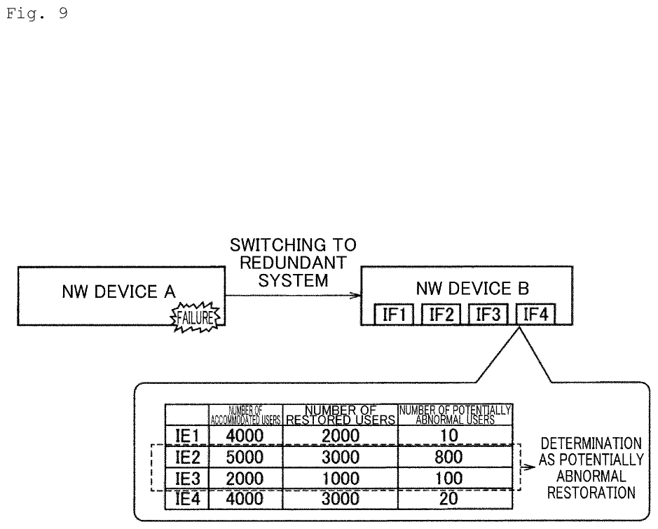

When a value obtained by dividing the estimation value (number of potentially abnormal users) of the above-mentioned number of users by the number of users (number of restored users) exhibiting current traffic exceeds a certain threshold value, as illustrated in FIG. 9, the determination unit 16 displays restoration in the division unit as potentially abnormal restoration by an alarm or on a GUI.

Each processing of from the above-mentioned Step S404 to Step S410 is executed repeatedly every minute to display a potentially abnormal restoration result that depends on the restoration ratio of the user at the time of execution. Therefore, it is possible to provide the technology capable of checking the normality of the service status of the entire user immediately and accurately.

Traffic prediction for an individual user varies depending on an individual user action, which often results in erroneous prediction. The above-mentioned processing is to obtain a probable result by statistically processing the results of individual traffic prediction in units of network facility.

[4. Effect]

According to this embodiment, a current estimated traffic amount of each user in the NW device 2 is calculated based on past traffic data of each user, the calculated current estimated traffic amount of each user and the current traffic amount of each user in the NW device 2′ from which the NW device 2 is switched are compared with each other, and when the number of users for which the current estimated traffic amount is larger than zero but the current traffic amount is zero exceeds a threshold value, restoration by switching to the NW device 2′ is determined to be abnormal. Therefore, it is possible to provide the technology capable of checking the normality of the service status of the entire user immediately.

Furthermore, according to this embodiment, the above-mentioned determination is performed by using the current estimated traffic amount of each user at the time of determination, which considers the communication restoration period of each user, and the determination accuracy is improved. Therefore, it is possible to provide the technology capable of checking the normality of the service status of the entire user immediately and accurately.

[5. Others]

The present invention is not limited to the above-mentioned embodiment, and can be modified in various manners within the scope of the gist of the present invention.

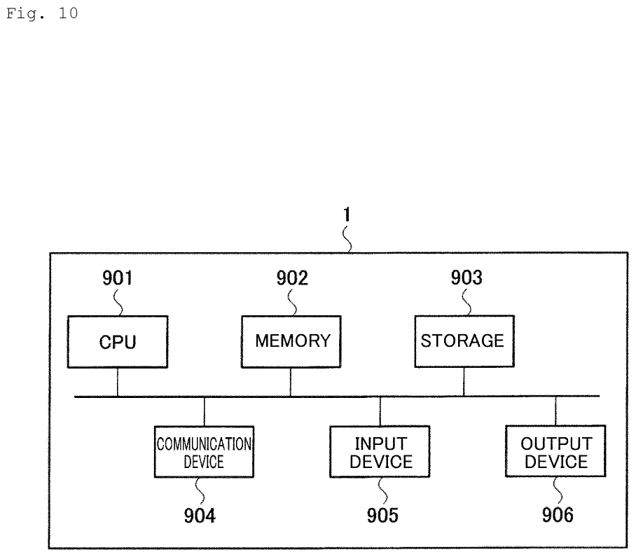

The restoration determination device 1 according to this embodiment can be, for example, a general-purpose computer system including a CPU (Central Processing Unit) 901, a memory 902, a storage 903 (Hard Disk Drive or Solid State Drive), a communication device 904, an input device 905, and an output device 906 as illustrated in FIG. 10. The memory 902 and the storage 903 are storage devices. In the computer system, the CPU 901 executes a predetermined program loaded into the memory 902 to implement each function of the restoration determination device 1.

The restoration determination device 1 may be implemented by one computer, or may be implemented by a plurality of computers. Furthermore, the restoration determination device 1 may be a virtual machine implemented in a computer. A program for the restoration determination device 1 can be stored in a computer-readable storage medium such as an HDD, an SSD, a USB (Universal Serial Bus) memory, a CD (Compact Disc), or a DVD (Digital Versatile Disc), or can be distributed via a network.

### REFERENCE SIGNS LIST

1 Restoration determination device
11 Collection unit
12 Learning unit
13 Estimation unit
14 Detection unit
15 Comparison unit
16 Determination unit
17 Output unit
2 NW device
3 Traffic collection device
4 Alarm collection device
5 Facility database
6 Failure information database

1. A restoration determination device configured to:
calculate, based on past traffic data of each user in a first network (NW) device, a current estimated traffic amount of the user;
compare the calculated current estimated traffic amount of the user with a current traffic amount of the user in a second NW device to which the first NW device is switched; and
determine restoration by switching to the second NW device to be abnormal based on a number of users for which (i) the current estimated traffic amount is greater than zero and (ii) the current traffic amount is zero exceeding a threshold value.

2. The restoration determination device according to claim 1, comprising:
a collection unit, implemented using one or more computing devices, configured to collect traffic data of each user;
a learning unit, implemented using one or more computing devices, configured to learn the traffic data of the user collected from the first NW device to generate a traffic demand estimation model for calculating a current estimated traffic amount of the user;
a comparison unit, implemented using one or more computing devices, configured to compare, after the first NW device is switched to the second NW device, the current estimated traffic amount of the user calculated by using the traffic demand estimation model with a current traffic amount of the user flowing through the second NW device; and
a determination unit, implemented using one or more computing devices, configured to determine the restoration by switching to the second NW device to be abnormal based on (i) the number of users for which the current estimated traffic amount is greater than zero and (ii) the current traffic amount is zero exceeding the threshold value.

3. The restoration determination device according to claim 2, further comprising:
an estimation unit, implemented using one or more computing devices, configured to learn, for each traffic pattern immediately before disconnection of communication, a communication restoration period of the user since disconnection of communication until resumption of communication to generate a communication restoration estimation model for calculating a communication restoration period of the user that depends on a predetermined traffic pattern,
wherein the estimation unit is configured to calculate a communication restoration period of the user that depends on a traffic pattern immediately before switching to the second NW device by using the communication restoration estimation model, and
wherein the determination unit is configured to perform the determination by using a current estimated traffic amount of the user at a time of the determination, based on the calculated communication restoration period of the user.

4. A restoration determination method to be executed by a restoration determination device, the restoration determination method comprising:
calculating, based on past traffic data of each user in a first network (NW) device, a current estimated traffic amount of the user;
comparing the calculated current estimated traffic amount of the user with a current traffic amount of the user in a second NW device to which the first NW device is switched; and
determining restoration by switching to the second NW device to be abnormal based on a number of users for which (i) the current estimated traffic amount is greater than zero and (ii) the current traffic amount is zero exceeding a threshold value.

5. A non-transitory recording medium storing a restoration determination program for causing a computer to perform operations comprising:
calculating, based on past traffic data of each user in a first network (NW) device, a current estimated traffic amount of the user;
comparing the calculated current estimated traffic amount of the user with a current traffic amount of the user in a second NW device to which the first NW device is switched; and
determining restoration by switching to the second NW device to be abnormal based on a number of users for which (i) the current estimated traffic amount is greater than zero and (ii) the current traffic amount is zero exceeding a threshold value.

6. The non-transitory recording medium according to claim 5, wherein the operations further comprise:
collecting traffic data of each user; and
learning the traffic data of the user collected from the first NW device to generate a traffic demand estimation model for calculating a current estimated traffic amount of the user,
wherein comparing the calculated current estimated traffic amount with the current traffic amount comprises comparing, after the first NW device is switched to the second NW device, the current estimated traffic amount of the user calculated by using the traffic demand estimation model with a current traffic amount of the user flowing through the second NW device.

7. The non-transitory recording medium according to claim 6, further comprising:
learning, for each traffic pattern immediately before disconnection of communication, a communication restoration period of the user since disconnection of communication until resumption of communication to generate a communication restoration estimation model for calculating a communication restoration period of the user that depends on a predetermined traffic pattern;
calculating a communication restoration period of the user that depends on a traffic pattern immediately before switching to the second NW device by using the communication restoration estimation model; and
performing the determination by using a current estimated traffic amount of the user at a time of the determination, based on the calculated communication restoration period of the user.
